(19) United States
(12) Patent Application Publication
(10) Pub. No.: US 2026/0307031 A1
(43) Pub. Date: Oct. 8, 2026

(54) HYDROGEN GENERATION DEVICE

(71) Applicant: Wen-Ta KUO, Taipei City (TW)

(72) Inventor: Wen-Ta KUO, Taipei City (TW)

(21) Appl. No.: 19/220,472

(22) Filed: May 28, 2025

(30) Foreign Application Priority Data
Apr. 2, 2025 (TW) 114112907

(51) Int. Cl. B01J 6/00; B01D 53/22; B01D 71/02; C01B 3/24; H05B 6/04; H05B 6/10

(52) U.S. Cl. CPC B01J 6/00; B01D 53/228; B01D 53/229; B01D 71/02; B01D 71/05; C01B 3/24; H05B 6/04; H05B 6/108; B01D 2256/16; C01B 2203/0272; C01B 2203/1241

(57) ABSTRACT

A hydrogen generation device includes a hydrogen generator body, a secondary coil, an eddy current generating unit, and at least one support member. The hydrogen generator body includes a chamber. One end part of the hydrogen generator body is provided with a first inlet for allowing a first substance to enter the chamber and a second inlet for allowing a second substance to enter the chamber. The other end part of the hydrogen generator body is provided with an outlet and an exhaust port. The secondary coil is wound around the exterior of the hydrogen generator body. The eddy current generating unit is disposed in the chamber at a position corresponding to the secondary coil. The support member has plural holes and is disposed in the chamber. The eddy current generating unit penetrates through the support member and is arranged in the chamber by the support member.

### CROSS REFERENCE TO RELATED APPLICATIONS

This Non-provisional application claims priority under 35 U.S.C. § 119 (a) on Patent Application No(s). 114112907 filed in Taiwan, Republic of China on Apr. 2, 2025, the entire contents of which are hereby incorporated by reference.

### BACKGROUND

### Technology Field

The present disclosure relates to a hydrogen generation device that utilizes thermal cracking to produce hydrogen.

### Description of Related Art

Hydrogen, as a clean and efficient energy carrier, plays a vital role in today's global energy transformation. First, the product of hydrogen combustion is water and is thus a zero-carbon emission energy option. Similar to electricity, hydrogen energy has advantages in industries that are difficult to electrify, such as heavy industries, long-distance transportations, and other fields. According to forecasts by the International Energy Agency (IEA) and the International Renewable Energy Agency (IRENA), by 2050, hydrogen energy will provide 12% to 13% of global final energy demand. However, the contribution of hydrogen energy in the global final energy demand is almost zero today.

In addition, hydrogen can be produced by electrolysis of water. In particular, when considering the renewable energy, the produced hydrogen is a pollution-free clean energy. When hydrogen reacts chemically with oxygen, it can produce electricity and pure water. Hydrogen can exist in gaseous or liquid form, which facilitates long-term storage and long-distance transportation, and can make up for the locational limitations of renewable energy.

In the industrial field, hydrogen is an important raw material for industries of, for example, synthetic ammonia, methanol, and petroleum refining. As the cost of renewable energy generation continues to decline, it is expected that by 2030, the cost of green hydrogen production in some regions will be comparable to that of traditional hydrogen production from fossil fuels, which will promote the widespread application of hydrogen energy in the industrial sectors. In summary, hydrogen plays a key role in driving global energy transformation, reducing greenhouse gas emissions, and promoting sustainable economic development. With technological advancement and policy support, the application scope of hydrogen energy will continue to expand, providing strong impetus for the optimization of the global energy structure.

For a long time, the use of thermal cracking or catalytic cracking of a substance, such as methane, to produce hydrogen has been widely used by the industry. However, in thermal cracking, a device that can generate high temperature must be prepared for providing high temperature to crack methane. The most common device includes, for example, a cracking furnace, a vacuum flash cracking device, or a plasma cracking device. Regarding the catalytic cracking device, although the hydrogen production effect thereof is good, it requires, in addition to high-temperature device, a catalyst to assist cracking process.

As for the above-mentioned various types of conventional high-temperature devices, although they can provide high temperature to crack gas and then produce hydrogen, most of the devices have problems such as high cost and difficult temperature control. In addition, these conventional devices may not suitable for producing smaller-scale hydrogen that is used in application of electricity generation.

Therefore, it is desired to provide a hydrogen generation device that has a low cost and a good temperature control, and is suitable for smaller-scale hydrogen production. In other words, an objective of this disclosure is to provide a hydrogen generation device that has a low cost, is easy to control the temperature, and can be suitable for smaller-scale hydrogen production.

### SUMMARY

To achieve the above, this disclosure provides a hydrogen generation device, which includes a hydrogen generator body, a secondary coil, an eddy current generating unit, and at least one support member. The hydrogen generator body has a chamber. One end part of the hydrogen generator body is provided with a first inlet configured for allowing a first substance to enter the chamber and a second inlet configured for allowing a second substance to enter the chamber, and another end part of the hydrogen generator body is provided with an outlet and an exhaust port. The secondary coil is wound around an exterior of the hydrogen generator body. The eddy current generating unit is disposed in the chamber at a position corresponding to where the secondary coil is wound. The support member is disposed in the chamber, and the eddy current generating unit is arranged in the chamber by the support member.

In one embodiment, the support member is formed with a support hole and a plurality of through holes, and the eddy current generating unit penetrates through the support hole so as to be arranged in the chamber.

In one embodiment, the hydrogen generation device further includes a primary coil circuit, which is coupling to the secondary coil and enables the secondary coil to generate a high-voltage alternating current. The high-voltage alternating current induces an alternating electromagnetic field in the chamber of the hydrogen generator body to cause the eddy current generating unit to generate an eddy current so as to generate a high temperature.

In one embodiment, a working voltage of the primary coil circuit is between 12V and 24V, and a voltage generated by the secondary coil is between 50 KV and 200 KV.

In one embodiment, the high temperature generated by the eddy current generating unit is between 1000° C. and 1600° C.

In one embodiment, the hydrogen generator body is made of quartz material or ceramic material.

In one embodiment, the first inlet is configured with a first nozzle, and the second inlet is configured with a second nozzle.

In one embodiment, the first substance includes methane, ethane, propane, butane, methanol, ethanol, ammonia, gaseous water molecules, or water mist.

In one embodiment, the second substance includes methane, ethane, propane, butane, methanol, ethanol, ammonia, gaseous water molecules, or water mist.

In one embodiment, the eddy current generating unit includes a column, at least one fixing member, and a refractory conductive material. The fixing member is disposed inside the column, and the refractory conductive material is disposed inside the column by the fixing member.

In one embodiment, the refractory conductive material includes a refractory metal or a refractory metal alloy.

In one embodiment, the refractory metal includes tungsten, molybdenum, or tantalum, and the refractory metal alloy includes tungsten alloy, molybdenum alloy, or tantalum alloy.

In one embodiment, the column is made of quartz material or ceramic material.

In one embodiment, the hydrogen generation device further includes a hydrogen separation membrane disposed in the chamber and located between the outlet and the exhaust port.

In one embodiment, the hydrogen separation membrane includes a ceramic membrane or a metal-ceramic composite membrane.

As mentioned above, the hydrogen generation device of this disclosure can utilize the alternating electromagnetic field generated by the secondary coil to cause the refractory conductive material of the eddy current generating unit to generate an eddy current, thereby producing a high temperature in the space near the eddy current generating unit. Therefore, the hydrogen generation device has a lower manufacturing cost and is easy to control the temperature. Furthermore, the hydrogen generation device utilizes the high temperature generated by the eddy current generating unit to cause a thermal cracking reaction between the first substance and the second substance in the chamber to generate hydrogen, so that it is suitable for smaller-scale hydrogen production.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic sectional view of a hydrogen generation device of this disclosure;

FIG. 2 is a top view of a support member of this disclosure;

FIG. 3 is a schematic sectional view of another hydrogen generation device of this disclosure, which is configured with a primary coil circuit;

FIG. 4 is a top view of another support member of this disclosure;

FIG. 5 is a schematic sectional view of another hydrogen generation device of this disclosure, which is configured with a first nozzle and a second nozzle;

FIG. 6 is a schematic sectional view of another hydrogen generation device of this disclosure;

FIG. 7 is a top view of another support member of this disclosure; and

FIG. 8 is a schematic sectional view of another hydrogen generation device of this disclosure, which is configured with a hydrogen separation membrane.

### DETAILED DESCRIPTION OF THE DISCLOSURE

The present disclosure will be apparent from the following detailed description, which proceeds with reference to the accompanying drawings, wherein the same references relate to the same elements.

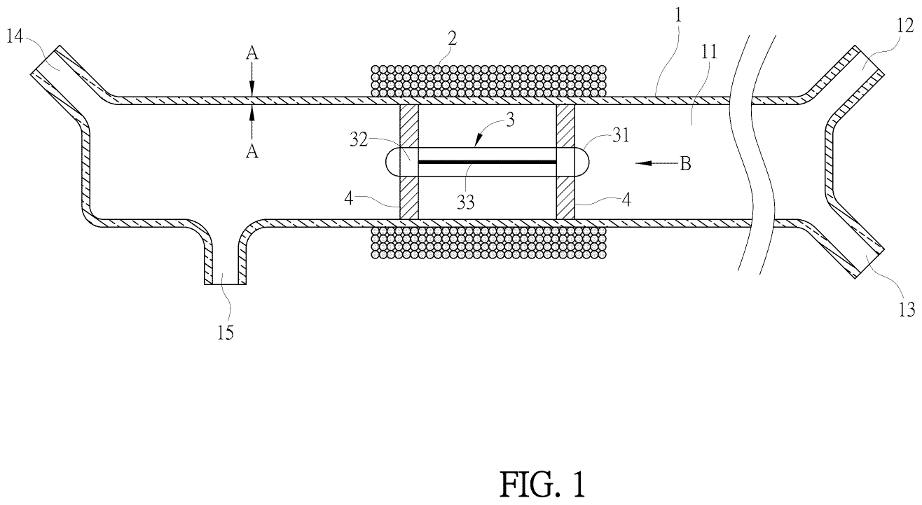

As shown in FIG. 1, a hydrogen generation device of this disclosure includes a hydrogen generator body 1, a secondary coil 2, an eddy current generating unit 3, and at least one support member 4. In this embodiment, the hydrogen generation device includes two support members 4.

The hydrogen generator body 1 has a chamber 11. One end part of the hydrogen generator body 1 is provided with a first inlet 12 and a second inlet 13. The first inlet 12 is configured for allowing a first substance to enter the chamber 11, and the second inlet 13 is configured for allowing a second substance to enter the chamber 11. In this embodiment, each of the first substance and the second substance may include methane, ethane, propane, butane, methanol, ethanol, ammonia, gaseous water molecules, or water mist. Another end part of the hydrogen generator body 1 is provided with an outlet 14 for outputting hydrogen and an exhaust port 15 for discharging the side products. To be noted, in practice, one of the first inlet 12 and the second inlet 13 may be turned off (closed), so that only one of the first substance and the second substance can be inputted into the chamber 11 of the hydrogen generator body 1.

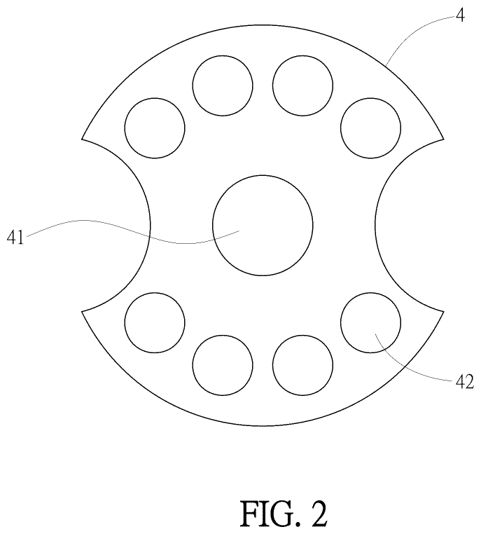

The secondary coil 2 is wound around the exterior of the hydrogen generator body 1. The eddy current generating unit 3 is disposed in the chamber 11 at a position corresponding to where the secondary coil 2 is wound. As shown in FIG. 2, the support member 4 is formed with a support hole 41 and a plurality of through holes 42, and is disposed in the chamber 11. The eddy current generating unit 3 penetrates through the support hole 41 of the support member 4 so as to be arranged in the chamber 11.

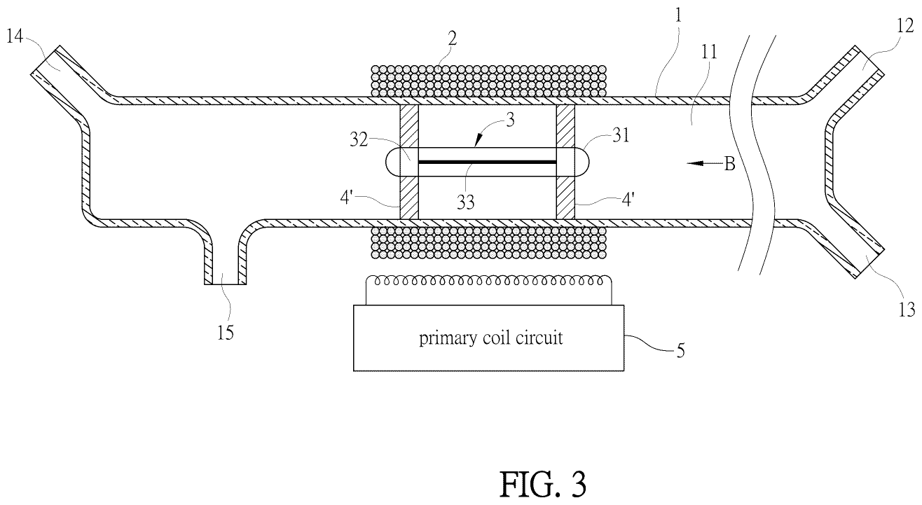

Referring to FIG. 3, the hydrogen generation device of this disclosure may further include a primary coil circuit 5, which is coupling to the secondary coil 2 and enables the secondary coil 2 to generate a high-voltage alternating current. The high-voltage alternating current induces an alternating electromagnetic field in the chamber 11 of the hydrogen generator body 1 to cause the refractory conductive material 33 of the eddy current generating unit 3 to generate an eddy current. This can generate a high temperature in the chamber 11 around the eddy current generating unit 3. In this embodiment, the working voltage of the primary coil circuit 5 is between 12V and 24V, and the voltage generated by the secondary coil 2 is between 50 KV and 200 KV. The high temperature generated by the eddy current generating unit 3 is between 1000° C. and 1600° C. By applying the high temperature of 1000° C. to 1600° C., the first substance and/or the second substance can undergo the thermal cracking to produce hydrogen.

The operation of the hydrogen generation device of this disclosure for generating hydrogen will be described below. When the first substance is methane, or when both the first substance and the second substance are methane, methane can be introduced into the chamber 11 through the first inlet 12 and/or through the second inlet 13. Then, the methane gas flows through the high-temperature area around the eddy current generating unit 3, so that the high-temperature cracking reaction of the methane can be induced so as to produce hydrogen and solid carbon. The chemical reaction is shown as the following reaction formula (1).

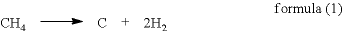

When the first substance is methane and the second substance is water mist or gaseous water molecules, methane can be introduced into the chamber 11 through the first inlet 12, and water mist or gaseous water molecules can be introduced into the chamber 11 through the second inlet 13. Then, the methane gas and water mist/gaseous water molecules flow through the high-temperature area around the eddy current generating unit 3, so that the methane recombination reaction and the water-gas shift reaction can be induced to generate hydrogen and carbon dioxide.

The chemical reactions are shown as the following reaction formulas (2) and (3).

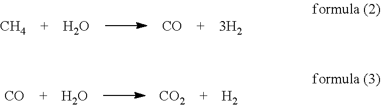

As mentioned above, the hydrogen produced by the thermal cracking is outputted through the outlet 14 and utilized later, while the side product (e.g. solid carbon or carbon dioxide) can be discharged through the discharging port 15.

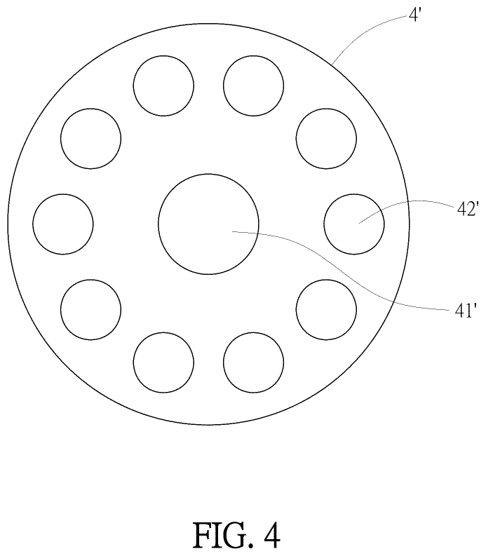

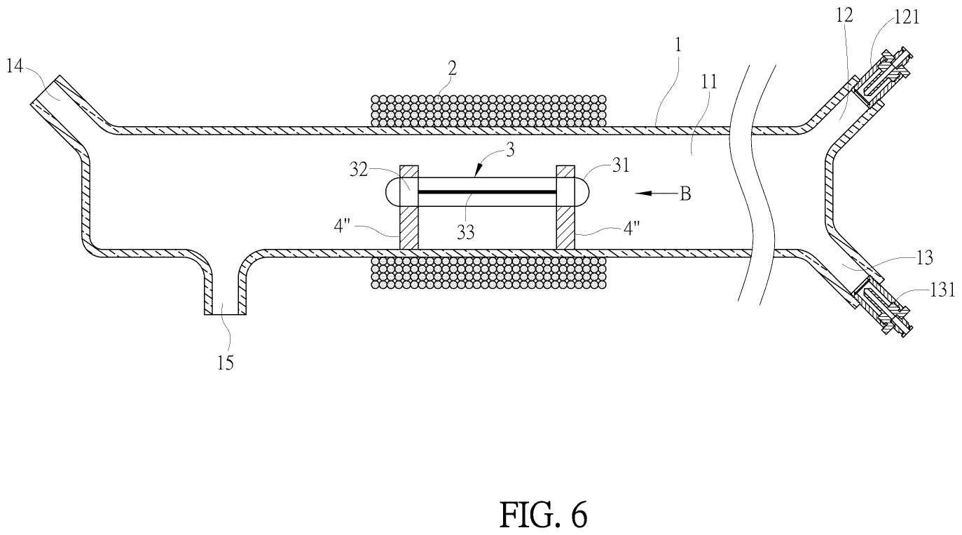

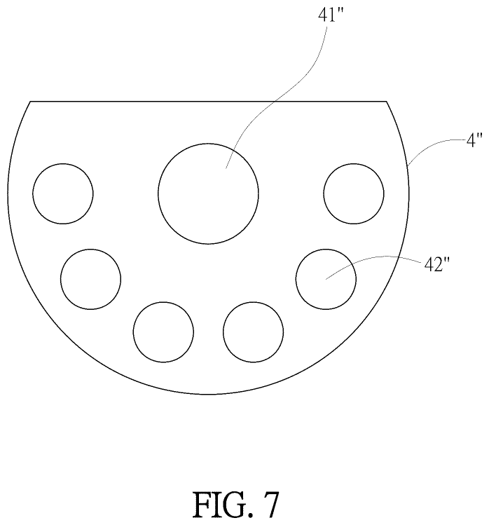

With reference to FIGS. 1 and 2, or FIGS. 3 and 4, or FIGS. 6 and 7, the eddy current generating unit 3 of the hydrogen generation device of this disclosure includes a column 31, two fixing members 32, and a refractory conductive material 33. In this embodiment, the column 31 can be made of quartz material or ceramic material. The refractory conductive material 33 is disposed in the column 31 through the fixing members 32. The eddy current generating unit 3 is disposed in the chamber 11 by means of the support member 4, 4′ or 4″. When viewed from the direction B in FIG. 1, FIG. 3 or FIG. 7, the support member 4, 4′ or 4″ has a support hole 41, 41′ or 41″, and a plurality of through holes 42, 42′ or 42″. The eddy current generating unit 3 is disposed in the chamber 11 by penetrating through the support member 4, 4′ or 4″ through the support hole 41, 41′ or 41″. To be noted, in this embodiment, the first substance or the second substance can flow through the plurality of through holes 42, 42′ or 42″ of the support member 4, 4′ or 4″ or through the gap between the support member 4, 4′ or 4″ and the hydrogen generator body 1, and undergo the thermal cracking reaction around the eddy current generating unit 3 to generate hydrogen.

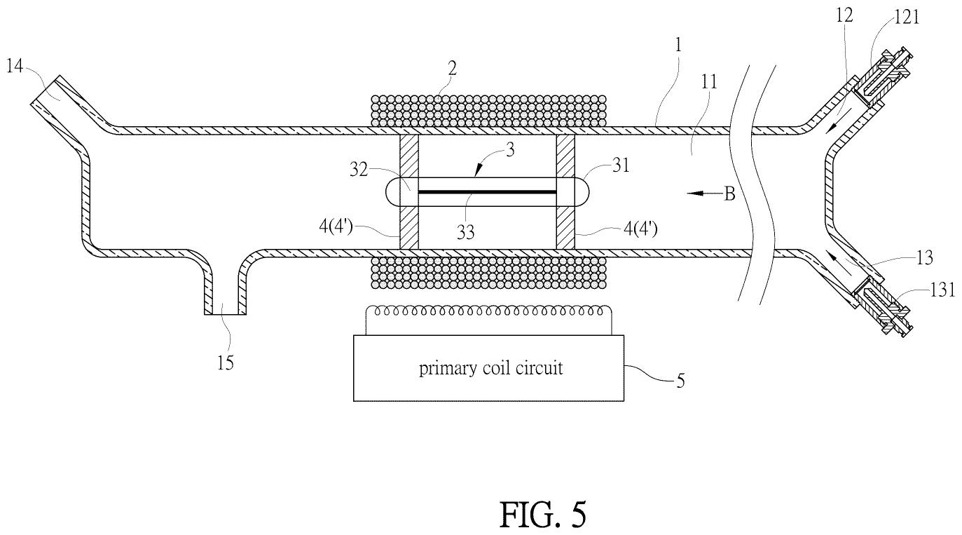

Referring to FIG. 5, the first inlet 12 and the second inlet 13 of the hydrogen generator body 1 of this disclosure can be configured with a first nozzle 121 and a second nozzle 131 respectively. The first nozzle 121 or the second nozzle 131 can be used to control the amount of the first substance or the second substance when the first substance or the second substance is introduced into the chamber 11. In addition, when the second substance is water, the water can be atomized through the second nozzle 131.

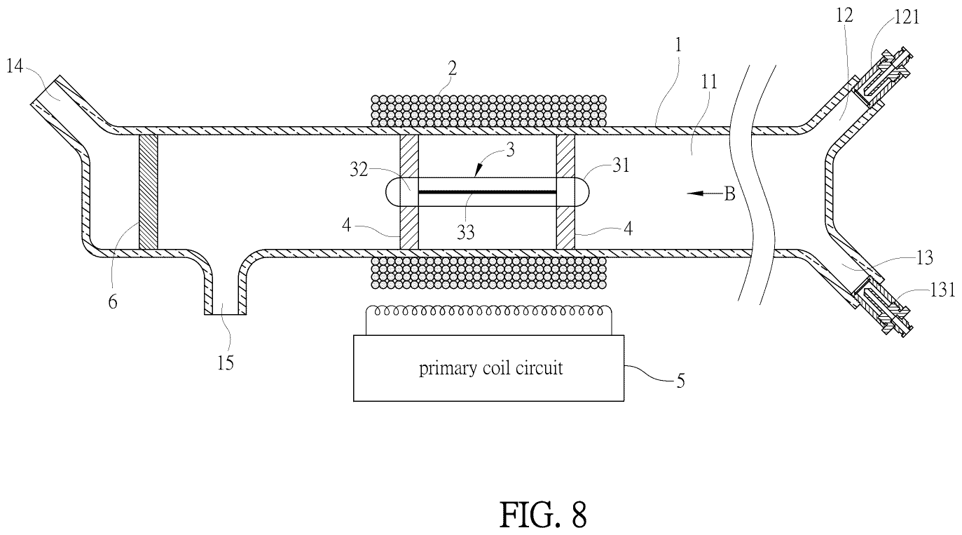

Referring to FIG. 8, the hydrogen generation device of this disclosure may further include a hydrogen separation membrane 6. The hydrogen separation membrane 6 is disposed in the chamber 11 and located between the outlet 14 and the discharging port 15. The hydrogen separation membrane 6 allows hydrogen to pass through and to be discharged through the outlet 14. The carbon or carbon dioxide (side product) is blocked by the hydrogen separation membrane 6 and then discharged through the discharging port 15. In this embodiment, the hydrogen separation membrane 6 includes a ceramic membrane or a metal-ceramic composite membrane.

In summary, the hydrogen generation device of this disclosure can utilize the alternating electromagnetic field generated by the secondary coil to cause the refractory conductive material 33 of the eddy current generating unit 3 to generate an eddy current, thereby producing a high temperature in the space near the eddy current generating unit 3. Therefore, the hydrogen generation device has a lower manufacturing cost and is easy to control the temperature. Furthermore, the hydrogen generation device utilizes the high temperature generated by the eddy current generating unit 3 to cause a thermal cracking reaction between the first substance and the second substance in the chamber 11 to generate hydrogen, so that it is suitable for smaller-scale hydrogen production.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A hydrogen generation device, comprising:
a hydrogen generator body having a chamber, wherein one end part of the hydrogen generator body is provided with a first inlet configured for allowing a first substance to enter the chamber and a second inlet configured for allowing a second substance to enter the chamber, and another end part of the hydrogen generator body is provided with an outlet and an exhaust port;
a secondary coil wound around an exterior of the hydrogen generator body;
an eddy current generating unit disposed in the chamber at a position corresponding to where the secondary coil is wound; and
at least one support member disposed in the chamber, wherein the eddy current generating unit is arranged in the chamber by the support member.

2. The hydrogen generation device of claim 1, wherein the support member is formed with a support hole and a plurality of through holes, and the eddy current generating unit penetrates through the support hole so as to be arranged in the chamber.

3. The hydrogen generation device of claim 1, further comprising:
a primary coil circuit coupling to the secondary coil and enabling the secondary coil to generate a high-voltage alternating current, wherein the high-voltage alternating current induces an alternating electromagnetic field in the chamber of the hydrogen generator body to cause the eddy current generating unit to generate an eddy current so as to generate a high temperature.

4. The hydrogen generation device of claim 3, wherein a working voltage of the primary coil circuit is between 12V and 24V, and a voltage generated by the secondary coil is between 50 KV and 200 KV.

5. The hydrogen generation device of claim 3, wherein the high temperature generated by the eddy current generating unit is between 1000° C. and 1600° C.

6. The hydrogen generation device of claim 1, wherein the hydrogen generator body is made of quartz material or ceramic material.

7. The hydrogen generation device of claim 1, wherein the first inlet is configured with a first nozzle, and the second inlet is configured with a second nozzle.

8. The hydrogen generation device of claim 1, wherein the first substance comprises methane, ethane, propane, butane, methanol, ethanol, ammonia, gaseous water molecules, or water mist.

9. The hydrogen generation device of claim 1, wherein the second substance comprises methane, ethane, propane, butane, methanol, ethanol, ammonia, gaseous water molecules, or water mist.

10. The hydrogen generation device of claim 1, wherein the eddy current generating unit comprises a column, at least one fixing member, and a refractory conductive material, the refractory conductive material comprises a refractory metal or a refractory metal alloy, and the refractory conductive material is disposed inside the column by the fixing member.

11. The hydrogen generation device of claim 10, wherein the refractory metal comprises tungsten, molybdenum, or tantalum, and the refractory metal alloy comprises tungsten alloy, molybdenum alloy, or tantalum alloy.

12. The hydrogen generation device of claim 10, wherein the column is made of quartz material or ceramic material.

13. The hydrogen generation device of claim 1, further comprising:
a hydrogen separation membrane disposed in the chamber and located between the outlet and the exhaust port.

14. The hydrogen generation device of claim 13, wherein the hydrogen separation membrane comprises a ceramic membrane or a metal-ceramic composite membrane.
